(19) United States
(12) Patent Application Publication
(10) Pub. No.: US 2007/0056040 A1
(43) Pub. Date: Mar. 8, 2007

(54) Data carrier belonging to an authorized domain

(75) Inventors: Sebastiaan Antonius Fransiscu Van Den Heuvel, Eindhoven (NL); Robert Paul Koster, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/566,760

(22) PCT Filed: Jul. 9, 2004
(86) PCT No.: PCT/IB04/02412

§ 371 Date: Jan. 31, 2006

(30) Foreign Application Priority Data
Jul. 31, 2003 (EP) 03300077.9

(51) Int. Cl. H04N 7/16

(52) U.S. Cl. 726/26

(57) ABSTRACT

The invention relates to a data carrier (DC) for carrying a data content (CONT) belonging to an authorized domain (AD). Said data carrier (DC) comprises a data carrier data right management system (M-DRM) ruled by first rights (R1) of exporting said data content (CONT) to a reading apparatus (RA). Said authorized domain comprises a domain data right management system (AD-DRM) ruled by second rights (R2) of exporting said data content (CONT) to a reading apparatus (RA), said second rights depending on whether the reading apparatus belongs to the authorized domain. The data carrier (DC) comprises said data content (CONT) stored within a data carrier data content file (CCF) having a data carrier format specified by said data carrier data right management system (M-DRM), a data carrier license (ML) comprising said first rights (R1) and a domain license (DL) comprising said second rights (R2), said domain license (DL) being stored as a data carrier domain license file (CDLF) having said data carrier format.

### FIELD OF THE INVENTION

The present invention relates to a data carrier for carrying data content belonging to an authorized domain. Said invention further relates to a reading apparatus for importing data content from such a data carrier. The invention also relates to a writing apparatus for exporting data content to such a data carrier. The invention also relates to a method of exporting data content from a writing apparatus to such a data carrier. The invention also relates to a method of importing data content from a data carrier to a reading apparatus.

The invention is particularly relevant in the domain of data right management for compact discs and digital versatile discs.

### DOMAIN OF THE INVENTION

Data Right Management (DRM) deals with the protection of rights and the management of rules related to accessing and processing digital information. These rights and rules govern various aspects of a digital content, such as who owns the digital content, how and when the digital content can be accessed, and how much the digital content should cost.

One type of digital right management scheme commonly used is a copy-based approach, in which a master copy of the digital content is stored and managed by a digital data right management system running on a server. The digital content is cryptographically tied to this system, which is charged with deciding when and if to provide requested digital content information. There are typically a limited number of available copies for each piece of digital content.

A data carrier usually comprises an internal copy-based data right management system. For instance, Digital Versatile Discs Video (DVD-Video) comprise a system called CSS, rewritable DVDs a CPRM system (Copy Protection for Recordable Media) and MemorySticks comprise a system called (Open) MagicGate. These systems prevent any copy being made of the digital content stored in the data carrier.

Another type of digital right management scheme is a domain-based approach. International Patent Application WO02/086725 describes a communication device operable in such a domain based data right management approach. An authorized domain contains a limited number of registered communication devices. Access to digital content that is bound to the domain is restricted to those communication devices that belong to the domain.

A drawback of such a domain based environment is that domain related data rights attached to a digital content are lost upon copying of the digital content into a data carrier such as, for instance, an optical storage medium.

### SUMMARY OF THE INVENTION

The object of the invention is to provide a solution which prevents a digital content from losing its domain related rights when copied into a data carrier.

This is achieved with a data carrier for carrying a data content belonging to an authorized domain, said data carrier comprising a data carrier data right management system, said data carrier data right management system being rules by first rights of exporting the data content to a reading apparatus, said authorized domain comprising a domain data right management system, said domain data right management system being ruled by second rights of exporting said data content to a reading apparatus, said second rights depending on whether said authorized domain comprises said reading apparatus, said data carrier comprising:
said data content, stored as a data carrier data content file having a data carrier format specified by said data carrier data right management system,
a data carrier license comprising said first rights,
a domain license comprising said second rights, said domain license being stored as a data carrier domain license file having said data carrier format.

With the invention, the data content exported from the domain to the data carrier is protected by the data carrier data right management system. Domain rights attached to the digital content are stored in the data carrier as a domain related license. The domain related license is also protected by the data carrier data right management system. Said domain rights are released to a reading apparatus belonging to the authorized domain when said reading apparatus reads the data carrier. Therefore, the domain rights are not lost upon a transfer of the data content from a domain data right management system to a data carrier data right management system.

### BRIEF DESCRIPTION OF THE DRAWINGS

The invention will be further described with reference to the accompanying drawings:

FIG. 1 is a schematic drawing of an authorized domain in accordance with the invention,

FIG. 2 is a functional block diagram of a method of exporting data content from an authorized domain to a data carrier in accordance with the invention,

FIG. 3 is a functional block diagram of a method of importing data content from a data carrier to a reading apparatus in accordance with the invention,

FIG. 4 is a schematic drawing of a data carrier in accordance with a first embodiment of the invention,

FIG. 5 is a schematic drawing of a data carrier in accordance with a first variant of the second embodiment of the invention,

FIG. 6 is a schematic drawing of a data carrier in accordance with a second variant of the second embodiment of the invention.

### DETAILED DESCRIPTION OF THE INVENTION

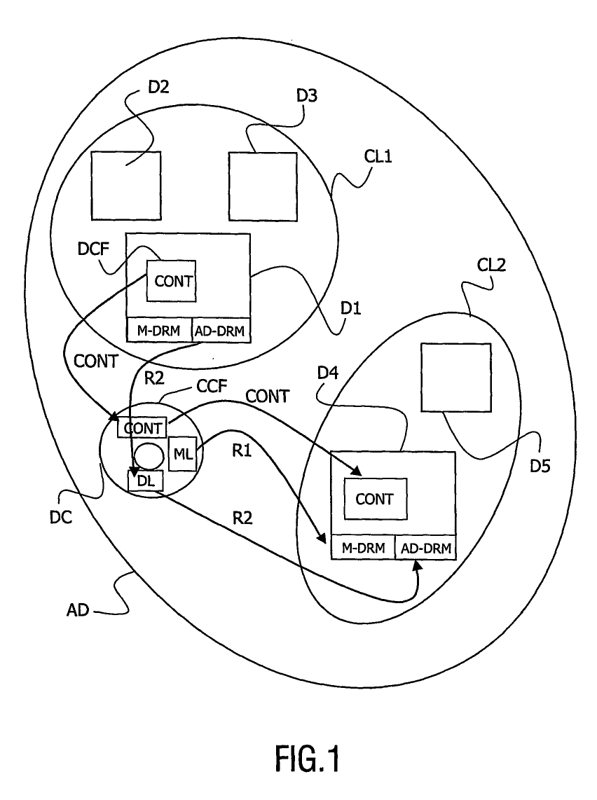

Referring to FIG. 1, an authorized domain AD comprises a plurality of unconnected clusters, for instance a first cluster CL₁ and a second cluster CL₂. The first cluster CL₁ comprises a first communication device D₁, a second communication device D₂ and a third communication device D₃. The second cluster CL₂ comprises a fourth communication device D₄ and a fifth communication device D₅. The communication devices of a same cluster are interconnected. The authorized domain AD is, for example, an in-home digital communication system comprising a plurality of personal digital communication devices like a PC, a mobile phone, a car stereo or a set-top box. Within this authorized domain, unrestricted and uncomplicated access to data content CONT like editing, storage or playback is provided, while data exchange from the authorized domain AD to another authorized domain is strictly controlled.

However, the invention is not restricted to in-home authorized domains, but concerns any authorized domain comprising communication devices which are connected to each other by any kind of network link, such as the Internet.

In order to handle internal and external data exchanges, the authorized domain AD comprises a domain data right management system AD-DRM. Such an AD-DRM system defines usage domain rights R₂, which describe the operations that a user can apply to the data content, depending on whether or not it belongs to the authorized domain. For instance, within the authorized domain, the domain rights usually allow unlimited copying of the data content. The AD-DRM system may implement one of the following approaches:
in a first approach, the communication devices (D₁-D₅) belonging to the authorized domain share a domain secret, for example a cryptographic key, which enables the user to decrypt the domain related data content CONT. In this case, the AD-DRM comprises means for encrypting and means for decrypting the data content into a domain content file DCF using such a domain secret,
in a second approach, communication between communication devices (D₁-D₅) is controlled so as to ensure that the domain rights R₂ are enforced. In this case, the AD-DRM system comprises licensing means for assigning a domain license DL comprising the domain rights R₂ to the data content CONT. These rights R₂ are checked before any transfer of this data content in order to ensure that only trusted devices can access the data content,
in a third approach, an additional protection of the domain license DL used in the second approach is provided, for example using a cryptographic key.

It should be noted that in the case of an authorized domain AD comprising communication devices linked to a service provider via the Internet, the AD-DRM system is a DRM system currently used on the Internet. Such a DRM system, for example EMMS from IBM, relies on a direct communication channel with the service provider. Data content is encrypted before being transmitted via the direct communication channel. The authorized domain may also comprise a digital broadcast system. In this case, the AD-DRM system may include a conditional access system such as, for example Philips Cryptoworks.

Referring to FIG. 1, the first cluster CL₁ and the second cluster CL₂ are not connected by a network. In order to transfer data content CONT from the first cluster CL₁ to the second cluster CL₂, a removable data carrier DC, such as, for example, an optical storage medium or a flash card is needed.

The data carrier DC in accordance with the invention comprises a data carrier data right management system M-DRM for protecting the data content CONT to be stored within the data carrier against illegal copying. Such a M-DRM system defines usage data carrier rights R₁, which describe the operations that a user can apply to the data content. Usually these data carrier rights allow unrestricted playback of the data content, but limit copying to a single backup only. The M-DRM system comprises licensing means for associating a data carrier license ML comprising the data carrier rights R₁ with the data content CONT. In addition, the M-DRM system usually, but not always, comprises means for encrypting the data content CONT. As a matter of fact, CDs do not include any native copy protection scheme, but all recent optical storage media like DVDs or Blu-Ray discs support some kind of M-DRM system.

It is to be noted that in most traditional data carriers, the M-DRM system is implemented partly in the data carrier, partly in the reading apparatus. For example, an optical storage medium like a DVD comprises M-DRM data, representing the usage rights or the cryptographic key to allow playing of the optical storage medium in any compatible reading apparatus, while the reading apparatus comprises the processing means for processing said necessary data, for example for running a decryption algorithm. However, some data carriers such as, for example, flash cards, comprise some chips and therefore have processing means for directly processing the decryption.

The data carrier DC in accordance with the invention comprises the encrypted or not encrypted data content CONT, stored within a data carrier content file DCCF having a data carrier format, specified by the data carrier data right management system M-DRM. The data carrier DC further comprises the data carrier license ML and the domain license DL.

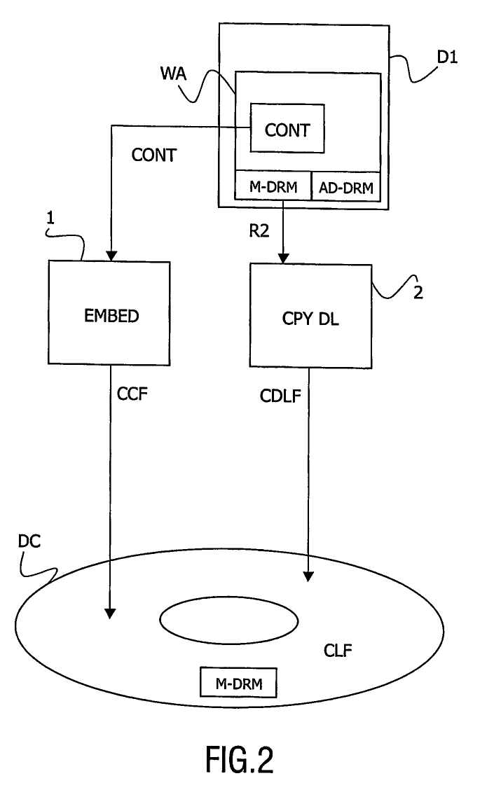

FIG. 2 depicts a method of exporting the data content CONT from a communication device D₁ comprising a writing apparatus WA to the data carrier DC in accordance with the invention. Said method comprises a step 1 of embedding the data content CONT into a data carrier data content file CCF, said data carrier data content file CCF having a data carrier format specified by the data carrier data right management system M-DRM. The exporting method in accordance with the invention further comprises a step 2 of copying the domain license DL into the data carrier DC as a data carrier domain license file CDLF. It is to be noted that the data carrier license ML is included in the data carrier and does not need to be copied.

It is assumed that the data carrier DC already comprises the data carrier license ML. As a matter of fact, said data carrier license belongs to the data carrier data right management system M-DRM, which may have been implemented in the data carrier during the manufacturing process.

Such a method is implemented by a writing apparatus WA comprising embedding means for embedding the data content CONT into the data carrier data content file CCF and domain data right management means for copying the domain license DL into the data carrier DC.

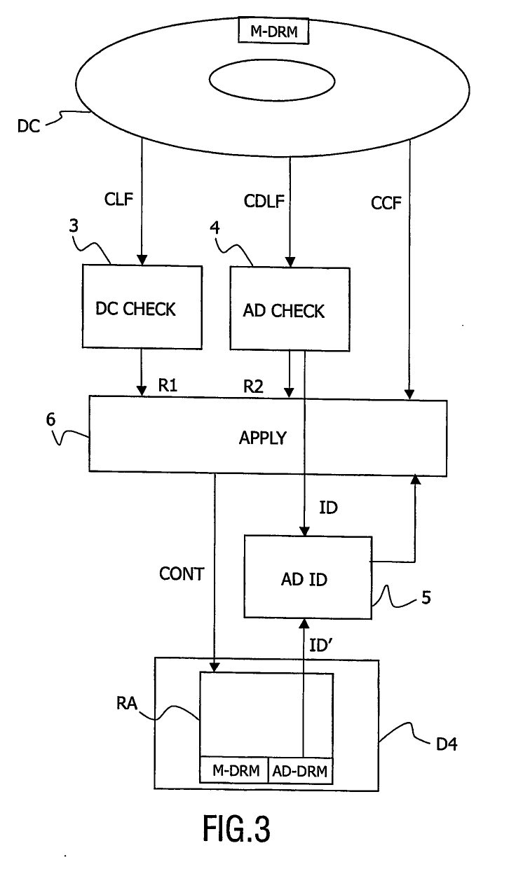

FIG. 3 depicts a method of importing the data content CONT from a data carrier DC to a reading apparatus RA in accordance with the invention, said reading apparatus RA being part of a communication device D₄. Said importing method comprises a step 3 of checking the data carrier license ML stored in the data carrier DC within the data carrier license file CLF in order to extract the first rights R₁ attached to the content CONT. The importing method further comprises a step 4 of checking the domain license DL stored in the data carrier DC within the data carrier domain license file CDLF, in order to extract the second rights R₂ attached to the content CONT. The importing method in accordance with the invention further comprises a step 5 of domain identification for checking whether the reading apparatus RA belongs to the authorized domain AD or not. The reading apparatus is assumed to belong to an authorized domain AD′. Said step 5, well known to those skilled in the art, for example consists in comparing a domain identifier ID of the authorized domain AD with a domain identifier ID′ of the authorized domain AD′. Said identifiers ID and ID′ are, for example, the domain secret or any domain identification code. In the data carrier DC, said identifier is stored, for example, in the domain license DL. The importing method in accordance with the invention finally comprises a step 6 of providing the reading apparatus RA with rights to access the data content (CONT), said rights depending on whether the reading apparatus belongs to the authorized domain. At least, the reading apparatus RA has the first rights R₁. If it belongs to the authorized domain AD, the second rights R₂ are added to the rights R₁.

Such a method is implemented by a reading apparatus comprising data carrier checking means for checking the data carrier license ML and outputting the first rights R₁, domain checking means for checking the domain license DL and outputting the second rights R₂, domain identification means for checking whether the reading apparatus RA belongs to the authorized domain AD, and data right application means for providing the reading apparatus RA with rights to access the data content CONT, said rights depending on whether the reading apparatus belongs to the authorized domain.

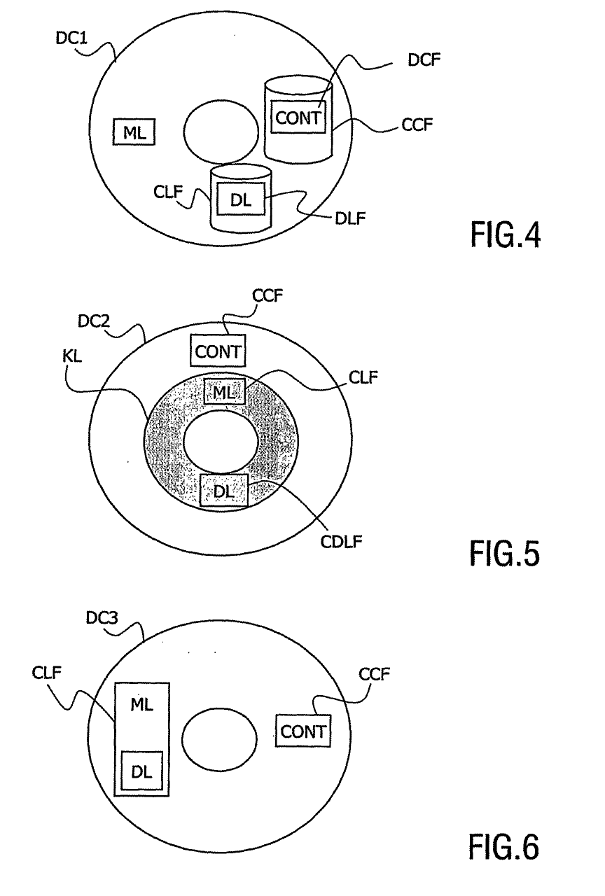

FIG. 4 depicts in a schematic way a data carrier DC, in accordance with a first embodiment of the invention. The data carrier DC, comprises a data carrier data content file CCF, which comprises a domain data content file DCF. The domain data content file DCF comprises the data content CONT. The domain data content DCF file has a domain format which is specified by the domain data right management system AD-DRM. The data carrier DC₁ further comprises a data carrier domain license file CDLF which comprises a domain license file DLF comprising the domain license DL and having the domain format.

Within the authorized domain AD, the data content CONT is stored in the domain data content file DCF and the domain license DL is stored in the domain license file DLF. In the first embodiment of the invention, said domain data content file DCF and said domain license file DLF are embedded as such into the data carrier data content file CCF and the data carrier domain license file CDLF, respectively. The domain data content file DCF and the domain license file DLF are only transported, but not interpreted by the data carrier data right management system M-DRM. Such an interpretation is achieved by the reading apparatus of the communication device importing the data content, which comprises AD-DRM means for processing the domain data content file DCF and the domain license file DLF.

An advantage of the first embodiment of the invention is that no change of the data carrier related data right management system M-DRM is needed in order to process the data content CONT stored in the data carrier DC₁ as a domain related data content, in particular in order to transfer and apply the domain rights R₂ attached to the data content CONT.

A variant to this first embodiment of the invention is to store the domain license DL in the same data carrier content file CCF as the data content CONT. An advantage of such a variant is that all domain related data are stored in a single file, which simplifies their processing by the reading apparatus.

Referring to FIG. 5, a data carrier DC₂ in accordance with a second embodiment of the invention comprises a data carrier data content file CCF in which the data content CONT has been converted from the domain format specified by the domain data right management system AD-DRM into the data carrier format.

An advantage is that the format in which the data content is stored is known by the data carrier, which makes playback of the data content CONT possible from the data carrier. In a first variant of this second embodiment of the invention, the data carrier further comprises a secure memory space, also called Key Locker KL, for storing the data carrier license ML and the domain license DL. Said key locker KL is a protected area in the data carrier, which can only be accessed by a compliant reading apparatus. Such an allocation of secure memory space in the data carrier DC₂ is achieved by an information binding mechanism (IBM), which binds information stored within the key locker KL to the data carrier DC₂. The key locker guarantees the following properties with respect to the data it contains:
confidentiality, because only the M-DRM system of the data carrier can access the data carrier license ML and the domain license DL,
integrity, because the M-DRM and the AD-DRM can detect unauthorized changes to the rights stored in the data carrier and domain licenses,
authenticity, because only the M-DRM system can store the data carrier and domain licenses.

An example of such an Information Binding Mechanism is a standard system, also called Key Locker, which has been created by Philips and Sony and is planned to be deployed in future products.

With this first variant of the second embodiment of the invention, the M-DRM system of the reading apparatus accesses the data stored in the key locker. If the reading apparatus comprises the AD-DRM system, the M-DRM system will release the domain license DL to the AD-DRM system. Consequently, if the reading apparatus only comprises the M-DRM system, only the first rights R₁ are applied to the data content CONT. If the reading apparatus comprises in addition the AD-DRM system, however, the M-DRM system will release the domain license to the AD-DRM system. Thus, the second rights R₂ of the data content are preserved and added to the first rights R₁. With the first variant of the second embodiment of the invention, the data carrier related data right management M-DRM system is changed in order to be able to check whether the domain license DL can be released or not to another DRM system included in the reading apparatus.

A first advantage of this first variant of the second embodiment of the invention is that the data carrier DC₂ is able to carry various licenses coming from several data right management systems and to release the licenses corresponding to that reading apparatus RA that reads the data carrier DC₂. For a reading apparatus not belonging to the authorized domain AD, the data carrier DC₂ will ignore the domain license DL. By contrast, the data carrier DC₂ will provide both data carrier and domain licenses for a reading apparatus belonging to the authorized domain AD.

Another advantage of the first variant of the second embodiment of the invention is that the solution proposed is not specific to AD-DRM systems. As a matter of fact, the key locker can store licenses coming from any non M-DRM system.

FIG. 6 depicts in a schematic way a data carrier DC₃ in accordance with a second variant of the second embodiment of the invention. The data carrier DC₃ comprises a data carrier license file CLF which comprises the domain license DL. In other words, the domain license DL is embedded into the data carrier license ML. The data carrier data right management system M-DRM is not able to understand the domain license DL, but it is asked to release it when the data carrier DC₃ is read by a reading apparatus RA comprising the AD-DRM system. An advantage of the second variant of the second embodiment of the invention is to provide an alternative to the information binding mechanism (IBM) for data carriers which do not have the information binding mechanism available.

It should be noted that the above-mentioned embodiments illustrate rather than limit the invention, and that those skilled in the art will be able to design many alternative embodiments without departing from the scope of the appended claims. In this respect the following closing remarks are made: there are numerous ways of implementing functions by means of items of hardware or software, or both. In this respect, the drawings of FIGS. 2 and 3 are very diagrammatic, each representing only one possible embodiment of the invention. Thus, although a drawing shows different functions as different blocks, this by no means excludes that a single item of hardware or software carries out several functions, nor does it exclude that a single function is carried out by an assembly of items of hardware or software, or both. In the claims, any reference signs places between parentheses shall not be construed as limiting the claims. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. A data carrier (DC, DC₁, DC₂, DC₃) for carrying a data content (CONT) belonging to an authorized domain (AD), said data carrier comprising a data carrier data right management system (M-DRM), said data carrier data right management system being ruled by first rights (R₁) of exporting the data content (CONT) to a reading apparatus (RA), said authorized domain (AD) comprising a domain data right management system (AD-DRM), said domain data right management system being ruled by second rights (R₂) of exporting said data content (CONT) to a reading apparatus (RA), said second rights (R₂) depending on whether said authorized domain comprises said reading apparatus, said data carrier comprising:
said data content (CONT), stored within a data carrier data content file (CCF) having a data carrier format specified by said data carrier data right management system (M-DRM),
a data carrier license (ML) comprising said first rights (R₁),
a domain license (DL) comprising said second rights (R₂), said domain license (DL) being stored as a data carrier domain license file (CDLF) having said data carrier format.

2. A data carrier as claimed in claim 1, wherein said data carrier data content file (CCF) comprises a domain data content file (DCF) including said data content (CONT), and said data carrier domain license file (CDLF) comprises a domain license file (DLF) including said domain license (DL), said domain data content file (DCF) and said domain license file (DLF) having a domain format, said domain format being specified by said domain data right management system (AD-DRM).

3. A data carrier as claimed in claim 1, wherein said data content (CONT) stored within the data carrier data content file (CCF) has been converted from a domain format specified by said domain data right management system (AD-DRM) to the data carrier format (M-DRM).

4. A data carrier as claimed in claim 2, wherein said data carrier (DC₂) comprises a secure memory space (KL) for storing the data carrier license (ML) and the domain license (DL).

5. A data carrier as claimed in claim 2, wherein said data carrier license (ML) comprises said domain license (DL).

6. A writing apparatus (WA) for exporting a data content (CONT) from an authorized domain (AD) to a data carrier (DC, DC₁, DC₂, DC₃), said data carrier comprising a data carrier data right management system (M-DRM) that is ruled by first rights (R₁) of exporting the data content (CONT) from the authorized domain (AD) to the data carrier, said authorized domain comprising a domain data right management system (AD-DRM) that is ruled by second rights (R₂) of exporting the data content within the authorized domain, said writing apparatus comprising:
embedding means for embedding said data content (CONT) into a data carrier data content file (CCF), said data carrier data content file having a data carrier format specified by the data carrier data right management system (M-DRM),
domain data right management means for copying a domain license (DL) into the data carrier (DC, DC₁, DC₂, DC₃) as a data carrier domain license file (CDLF) having said data carrier format, said domain license (DL) comprising said second rights (R₂).

7. A reading apparatus (RA) for importing a data content (CONTH) belonging to an authorized domain (AD) from a data carrier (DC, DC₁, DC₂, DC₃), said data carrier comprising a data carrier license (ML) comprising first rights (R₁) of exporting the data content (CONT) from said data carrier to said reading apparatus (RA), said data carrier further comprising a domain license (DL) comprising second rights (R₂) of exporting said data content from said data carrier to said reading apparatus (RA), said second rights depending on whether said authorized domain (AD) comprises said reading apparatus (RA) , said reading apparatus comprising:
data carrier checking means for checking said data carrier license (ML) and outputting said first rights (R₁),
domain checking means for checking said domain license (DL) and outputting said second rights (R₂),
domain identification means for checking whether the reading apparatus (RA) belongs to the authorized domain (AD),
data right application means for providing the reading apparatus (RA) with rights to access the data content (CONT), said rights depending on said first and second rights (R₁, R₂) and on whether the reading apparatus belongs to the authorized domain.

8. A method of exporting a data content (CONT) from an authorized domain (AD) into a data carrier (DC, DC₁, DC₂, DC₃), said data carrier comprising a data carrier data right management system (M-DRM) that is ruled by first rights (R₁) of exporting the data content (CONT) from the authorized domain into the data carrier, said authorized domain (AD) comprising a domain data right management system (AD-DRM) that is ruled by second rights (R₂) of exporting the data content (CONT) within the authorized domain (AD), said method comprising the steps of:
embedding (1) the data content (CONT) into a data carrier data content file (CCF), said data carrier data content file having a data carrier format specified by the data carrier data right management system (M-DRM),
copying (2) a domain license (DL) into the data carrier (DC, DC₁, DC₂, DC₃), said domain license comprising said second rights (R₂).

9. A method of importing a data content (CONT) from a data carrier (DC, DC₁, DC₂, DC₃) to a reading apparatus (RA), said data content (CONT) belonging to an authorized domain (AD), said data carrier comprising a data carrier data right management system (M-DRM) that is ruled by first rights (R₁) of exporting the data content (CONT) from the data carrier to a reading apparatus, said authorized domain (AD) comprising a domain data right management system (AD-DRM) that is ruled by second rights (R₂) of exporting the data content (CONT) from the data carrier (DC, DC₁, DC₂, DC₃) to the reading apparatus (RA), said second rights (R₂) depending on whether the authorized domain (AD) comprises said reading apparatus, said method comprising the steps of:
checking (3) a data carrier license (ML) stored in the data carrier, said data carrier related license comprising said first rights (R₁),
checking (4) a domain license (DL) stored in the data carrier, said domain license comprising said second rights (R₂),
identifying (5) whether the reading apparatus (AD) belongs to the authorized domain (AD),
providing (6) the reading apparatus (RA) with rights to access the data content (CONT), said rights depending on said first and second rights (R₁, R₂) and on whether the reading apparatus belongs to the authorized domain.
